(19) United States
(12) Patent Application Publication
(10) Pub. No.: US 2003/0188859 A1
(43) Pub. Date: Oct. 9, 2003

(54) INTEGRATED HEAT EXCHANGER

(76) Inventor: HIRONORI MURAMOTO, TOKYO (JP)

Correspondence Address: SUGHRUE MION ZINN MACPEAK & SEAS PLLC, 2100 PENNSYLVANIA AVE NW, WASHINGTON, DC, 200373213

(21) Appl. No.: 09/371,494

(22) Filed: Aug. 10, 1999

Related U.S. Application Data
(63) Continuation-in-part of application No. 09/015,783, filed on Jan. 29, 1998, now abandoned.

(30) Foreign Application Priority Data
Jan. 29, 1997 (JP) 9-15252

(51) Int. Cl. F28D 7/10; G05D 23/00

(52) U.S. Cl. 165/297; 165/140

(57) ABSTRACT

An integrated heat exchanger which includes a radiator adjoining a condenser and shares corrugated fins disposed in a core formed between the radiator and the condenser, the heat exchanger including a partition for dividing the inside of a tank of the radiator into which cooling water flows; and opening/closing means which is disposed in the partition so as to open when the temperature of the cooling water reaches a given temperature or more, as well as to close when the temperature of the cooling water is less than the given temperature.

This is a Continuation-In-Part of application Ser. No. 09/015,783, filed on Jan. 29, 1998, which is incorporated herein by reference.

### BACKGROUND OF THE INVENTION

1. Field of the Invention

The present invention relates to an integrated heat exchanger comprising a radiator adjoining a condenser, and corrugated fins which are provided in a core formed between the radiator and the condenser and are shared between them.

2. Description of the Related Art

There has recently been developed a so-called integrated heat exchanger comprising a condenser for cooling purposes which is joined to the front surface of the radiator. FIG. 6 shows an integrated heat exchanger of this type, wherein a condenser 1 is provided in front of a radiator 2.

The condenser 1 comprises a pair of condenser tanks 3, 3 which are spaced a given distance away from and are opposite to each other and a core 4 formed between the pair of condenser tanks 3, 3. The radiator 2 comprises a pair of radiator tanks 5, 5 which are spaced a given distance away from and are opposite to each other and the core 4 formed between the pair of radiator tanks 5, 5.

In this integrated heat exchanger, tubes 6 for use with the condenser and tubes 7 for use with the radiator are provided in the core 4. Wide corrugated fins 8 are mounted so as to extend over the tubes 6, 7 by brazing and are shared between the condenser 1 and the radiator 2.

However, in such an existing integrated heat exchanger, the corrugated fins 8 are shared between the condenser 1 and the radiator 2, and hence a coolant which circulates through the condenser tubes 6 and has a comparatively low temperature receives heat from cooling water which has a comparatively high temperature and circulates through the radiator tubes 7 by way of the corrugated fins 8, thereby degrading the cooling capability of the condenser 1.

More specifically, for example, when the engine of an automobile is in an idling state, a drive wind does not flow into the core 4, and hence the cooling ability of the coolant of the condenser 1 and the cooling water of the radiator 2 is degraded. However, when the engine is in an idling state, the revolution speed of the engine is low. For this reason, the ability of the radiator 2 to cool the cooling water becomes insignificant, whereas the ability of the condenser 1 to cool the coolant becomes significant. At this time, if heat is transmitted from the cooling water of the radiator 2 to the coolant of the condenser 1, the cooling ability of the condenser 1 will be extremely deteriorated.

### SUMMARY OF THE INVENTION

The present invention has been conceived to solve such a problem in the conventional art, and the object of the present invention is to provide an integrated heat exchanger capable of significantly reducing a decrease in the cooling ability of the condenser caused by the influence of heat from the cooling water of the radiator.

According to the present invention, there is provided an integrated heat exchanger comprising: a radiator; a condenser adjoining the radiator and sharing corrugated fins with the radiator; and opening/closing means being disposed inside of a tank of the radiator into which cooling water flows so as to open an inner space of the tank when a temperature of the cooling water reaches a given temperature or more, as well as to partition the inner space of the tank when the temperature of the cooling water is less than the given temperature.

In the integrated heat exchanger according to the present invention, the opening/closing means may comprise a partition formed on an inner side of the tank and having a through hole, and a valve for opening and closing the through hole of the partition.

Further, the valve may comprise a shape memory alloy.

In the integrated heat exchanger according to the present invention, for example, when the automobile climbs a gradient, a heavy load is exerted on the engine, so that the temperature of the cooling water of the radiator increases to a given temperature or more. At this time, the opening/closing means is opened thereby permitting the cooling water to flow through all the radiator tubes provided in the core. Heat is transferred to the outside air from the cooling water through all the corrugated fins provided in the core.

In contrast, for example, when the automobile is in an idling state, no load is substantially exerted on the engine, so that the temperature of the cooling water of the radiator decreases to a given temperature or less. At this time, the opening/closing means is closed thereby permitting the cooling water to flow through only a part of the radiator tubes provided in the core. Accordingly, heat is transferred to the outside air from the cooling water through the part of the corrugated fins provided in the core.

More specifically, when the engine is in an idling state, heat is transferred to the outside air from the cooling water of the radiator through only the part of the corrugated fins provided in the core. Therefore, the remaining corrugated fins are used only for transfer of heat from the coolant of the condenser to the outside air. Therefore, the influence of heat to the condenser from the cooling water of the radiator is reduced.

That is, when the engine is in the idling state, the area of the core which exclusively contributes to heat exchange of the condenser increases more as compared with the case when a heavy load is exerted on the engine.

Further, a valve made of a shape memory alloy may be used for the opening/closing means. When the temperature of the cooling water of the radiator reaches a given temperature or more, the partition is opened. In contrast, when the temperature of the cooling water does not reach the given temperature, the partition is closed.

Still further, the condenser and the radiator are disposed in such a positional relationship that the lower temperature side of the coolant of the condenser overlaps a part of the radiator tubes through which the cooling water does not flow when the automobile is in an idling state and the opening/closing means is closed. Under this structure, it becomes possible to prevent the cooled coolant of the condenser from being reheated by the heat of the cooling water of the radiator which is conducted from the radiator tubes to the condenser tubes through the corrugated fins.

Features and advantages of the invention will be evident from the following detailed description of the preferred embodiments described in conjunction with the attached drawings.

### BRIEF DESCRIPTION OF THE DRAWINGS

In the accompanying drawings:

FIG. 1 is a cross-sectional view showing a radiator shown in FIG. 2;

FIG. 2 is a lateral cross-sectional view showing an integrated heat exchanger according to one embodiment of the present invention;

FIG. 3 is an explanative view showing a state in which the opening/closing means is closed;

FIG. 4 is a schematic plan view showing a positional relationship between the radiator and the condenser;

FIG. 5 is an explanative view showing a state in which the opening/closing means is closed according to another embodiment of the present invention; and

FIG. 6 is a cross-sectional view showing an example of the integrated heat exchanger.

### DETAILED DESCRIPTION OF THE PREFERRED EMBODIMENTS.

By reference to the accompanying drawings, an embodiment of the present invention will be described in detail hereinbelow.

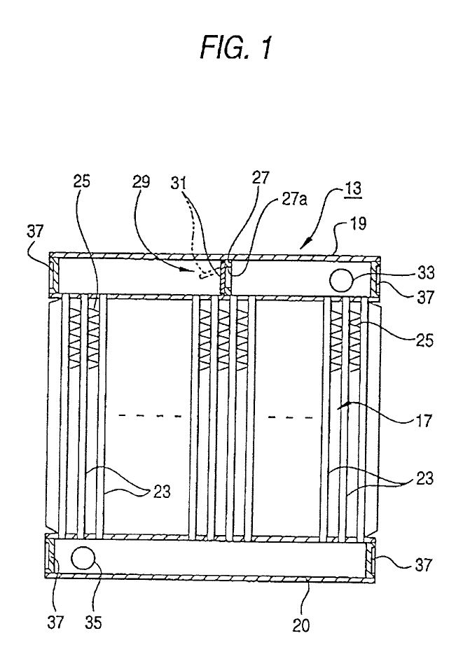

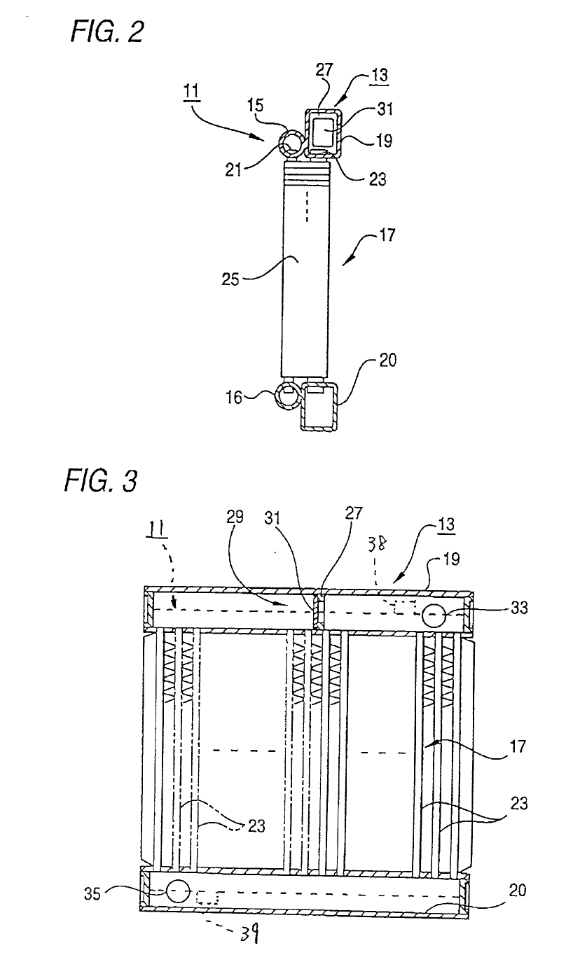

FIG. 1 is a longitudinal cross-sectional view showing a radiator of a heat exchanger shown in FIG. 2, and FIG. 2 shows an integrated heat exchanger according to the present invention.

In the integrated heat exchanger shown in FIG. 2, a condenser 11 is provided in front of a radiator 13.

The condenser 11 comprises a pair of condenser tanks 15, 16 which are spaced a given distance apart from and are opposite to each other, and a core 17 formed between the condenser tanks 15, 16.

The radiator 13 comprises a pair of radiator tanks 19, 20 which are spaced a given distance apart from and are opposite to each other, and the core 17 formed between the radiator tanks 19, 20.

Tubes 21 for use with the condenser and tubes 23 for use with the radiator are provided in the core 17.

Wide corrugated fins 25 are brazed so as to extend over the tubes 21, 23, and the corrugated fins 25 are shared between the condenser tubes 21 and the radiator tubes 23.

In the present embodiment, the condenser tank 15, the radiator tank 19, the condenser tank 16, and the radiator tank 20 are integrally formed from aluminum by extrusion molding.

The condenser tanks 15, 16 are cylindrically formed, and the radiator tanks 19, 20 are rectangularly formed.

As shown in FIG. 1, in the present embodiment, a rectangular partition 27 is formed so as to divide the inside of the upper radiator tank 19 of the radiator 13 into which cooling water flows.

A rectangular through hole 27a is formed in this partition 27, and a valve 31 constituting the open-close means 29 is disposed so as to cover the through hole 27a.

The valve 31 is formed from a shape memory alloy such as nickel-titanium alloy into a rectangular plate. When the temperature of the cooling water is less than a given temperature, the valve 31 has a straight cross section as designated by a solid line shown in FIG. 1, thereby closing the through hole 27a.

In contrast, when the temperature of the cooling water has reached the given temperature or more, the valve 31 becomes warped in the direction opposite to the through hole 27a thereby having a warped cross section such as that designated by a two-dot chain line shown in FIG. 1. As a result, the through hole 27a is opened.

More specifically, the opening/closing means 29 is closed when the temperature of the cooling water flowing into the radiator tank 19 reaches the given temperature or more. In contrast, when the temperature of the cooling water is less than the given temperature, the opening/closing means 29 is closed.

In FIG. 1, reference numerals 33, 35 designate an inlet pipe and an outlet pipe, respectively. Further, reference numeral 37 designates an end plate.

In the foregoing integrated heat exchanger, for example, when the automobile climbs a gradient, a heavy load is exerted on the engine, so that the temperature of the cooling water of the radiator 13 increases to a given temperature or more. At this time, as designated by the two-dot chain line show in FIG. 1, the valve 31 of the opening/closing means 29 is opened thereby permitting the cooling water to flow through all the radiator tubes 23 provided in the core 17. Heat is transferred to the outside air from the cooling water through all the corrugated fins 25 provided in the core 17.

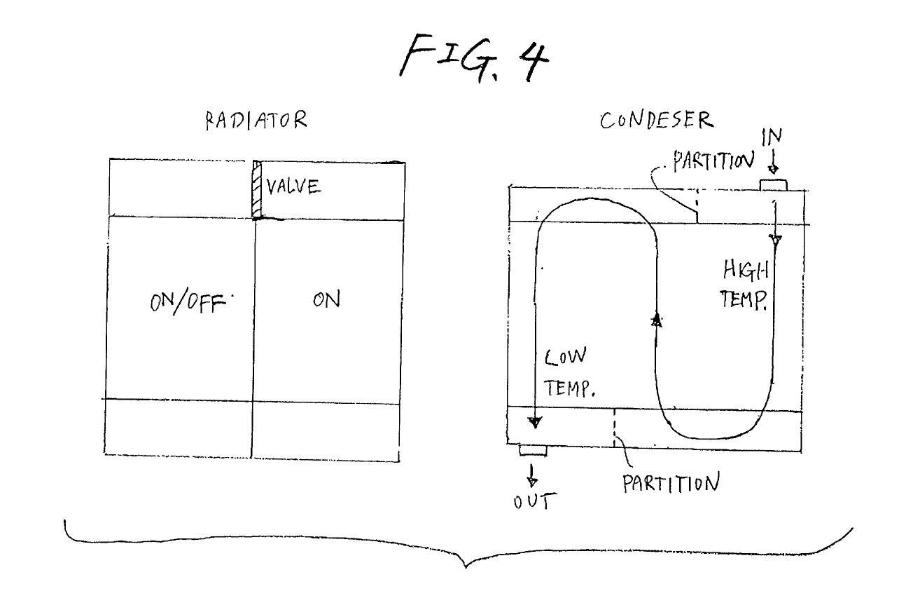

In contrast, for example, when the automobile is in an idling state, no load is substantially exerted on the engine, so that the temperature of the cooling water of the radiator 13 decreases to a given temperature or less. At this time, as designated by the solid line shown in FIG. 3, the valve 31 of the opening/closing means 29 is closed thereby permitting the cooling water to flow through only a part of the radiator tubes 23 provided in the core 17 (indicated by the solid line shown in FIG. 3). Accordingly, heat is transferred to the outside air from the cooling water through the part of the corrugated fins 25 provided in the core 17.

In the integrated heat exchanger having the foregoing construction, the partition 27 is formed so as to divide the inside of the upper radiator tank 19 of the radiator 13 into which cooling water flows. The partition 27 is provided with the opening/closing means 29 that is opened when the temperature of the cooling water reaches the given temperature or more and is closed when the temperature of the cooling water is less than the given temperature. Accordingly, a reduction in the cooling ability of the condenser 11 caused by the influence of heat from the cooling water of the radiator 13 can be significantly reduced when compared with a reduction in the cooling ability of the condenser of the existing heat exchanger.

In short, in the foregoing integrated heat exchanger, when the engine is in an idling state, heat is exchanged between the cooling water of the radiator 3 and the outside air through only the part of the corrugated fins 25 (which are in contact with the tubes 23 designated by the solid line shown in FIG. 3) provided in the core 17. Therefore, the remaining corrugated fins 25 (which are in contact with the tubes 23 designated by the two-dot chain line shown in FIG. 3) are used only for transfer of heat from the coolant of the condenser 11 to the outside air. The influence of heat on the condenser 11 from the cooling water of the radiator 13 is reduced.

Further, in the present embodiment, an inlet pipe 38 of the condenser 11 is disposed adjacent to the inlet pipe 33 of the radiator 13, and an outlet pipe 39 of the condenser 11 is disposed adjacent to the outlet pipe 35 of the radiator 13 as shown in FIG. 3. In this structure, the coolant just entered into the inlet pipe 38 of high temperature flows in the radiator tubes 23 designated by the solid line in FIG. 3. On the other hand, the coolant just before outgoing from the outlet pipe 39 of low temperature flows in the radiator tubes 23 designated by the two-dot chain line in FIG. 3. This mechanism is discussed with reference to FIG. 4.

FIG. 4 shows a schematic plan view showing a positional relationship between the radiator and the condenser. As shown in FIG. 4, generally, partitions not shown are provided in the condenser tanks so the coolant flows in the core of the condenser while returning with a given number (one turn in FIG. 4). The coolant is cooled while proceeding along this flowing path.

In the radiator of FIG. 4, “ON” side shows a group of the radiator tubes which corresponds to radiator tubes 23 designated by the solid line in FIG. 3. “ON/OFF” side shows a group the radiator tubes which corresponds to radiator tubes 23 designated by the two-dot chain line in FIG. 3.

Under this structure, the coolant of high temperature flows adjacent to the “ON” side of the radiator tubes, and the coolant of low temperature flows adjacent to the “ON/OFF” side of the radiator tubes.

As aforementioned, in the idling state of the automobile, the cooling water does not flow in the “ON/OFF” side of the radiator tubes. So there is no fear that the cooling water of the radiator reheats the coolant of the condenser through the corrugated fins. Consequently, cooling performance of the condenser is further enhanced.

In FIG. 4, partitions are provided in both of upper and lower tanks of the condenser. However, only one partition can be provided at least in one tank of the inlet pipe side. If one partition is provided in the upper tank of FIG. 4, the outlet pipe of the condenser is provided in the upper tank. The coolant returns only one time at the lower tank side. Also in this structure, the coolant of high temperature flows adjacent to the “ON” side of the radiator tubes, and the coolant of low temperature flows adjacent to the “ON/OFF” side of the radiator tubes, and the aforementioned effect can be obtained.

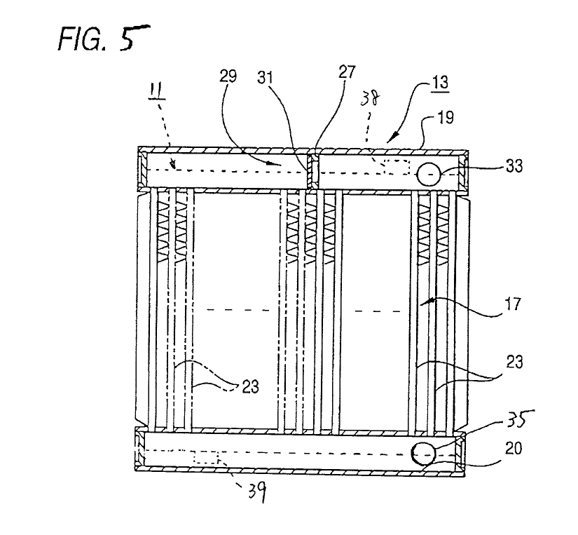

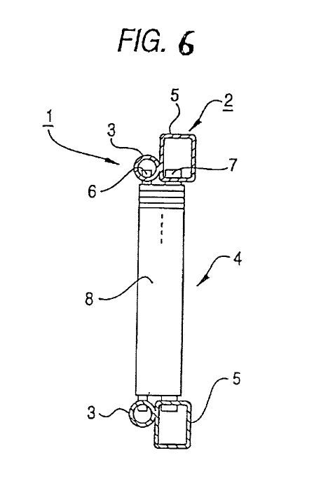

FIG. 5 shows another embodiment of the present invention. In this embodiment, the outlet pipe 35 of the radiator 13 is positioned far away from the outlet pipe 39 of the condenser 11. Also in this embodiment, same effect as the embodiment in FIG. 3 can be obtained.

In the foregoing integrated heat exchanger, the valve 31 formed from a shape memory alloy is used for the opening/closing means 29. Therefore, when the temperature of the cooling water of the radiator 13 reaches the given temperature or more, the partition 27 can readily and reliably be opened. Further, when the temperature of the cooling water is less than the given temperature, the partition 27 can readily and reliably be closed.

Although the explanation has described the foregoing embodiment with reference to the example in which the valve 31 made of a shape memory alloy is used for the opening/closing means 29, the present invention is not limited to this embodiment. For example, a thermo-valve, a butterfly valve, a pressure opening/closing valve, or an electromagnetic valve may also be used as the valve.

Although the explanation has described the embodiment with reference to the example in which the present invention is applied to the integrated heat exchanger integrally comprising the radiator tank 19, the condenser tank 15, the radiator tank 20, and the condenser tank 16, the present invention is not limited to such an embodiment. The present invention can be applied to an integrated heat exchanger separately comprising radiator tanks and condenser tanks.

Further, although the explanation has described the embodiment with reference to a type of heat exchanger in which cooling water and coolant flow in the vertical direction. However, the present invention can be applied to another type of the heat exchanger in which cooling water and/or coolant flow in the lateral direction.

As has been described above, according to the present invention, there is provided an integrated heat exchanger comprising a partition for dividing the inside of a tank of the radiator into which cooling water flows, and opening/closing means which is disposed in the partition so as to open when the temperature of the cooling water reaches a given temperature or more, as well as to close when the temperature of the cooling water is less than the given temperature. Accordingly, a reduction in the cooling ability of the condenser caused by the influence of heat from the cooling water of the radiator can be significantly reduced when compared with a reduction in the cooling ability of the condenser of the existing heat exchanger.

Further, the valve formed from a shape memory alloy can be used for the opening/closing means. Therefore, when the temperature of the cooling water of the radiator reaches the given temperature or more, the partition can readily and reliably be opened. Further, when the temperature of the cooling water is less than the given temperature, the partition can readily and reliably be closed.

Still further, the condenser and the radiator are disposed in such a positional relationship that the lower temperature side of the coolant of the condenser overlaps a part of the radiator tubes through which the cooling water does not flow when the automobile is in an idling state. So there is no fear that the cooling water of the radiator reheats the coolant of the condenser through the corrugated fins. Consequently, cooling performance of the condenser is further enhanced.

Although the invention has been described in its preferred form with a certain degree of particularity, it is understood that the present disclosure of the preferred form can be d arrangement of parts without departing from the spirit and the scope of the invention as hereinafter claimed.

What is claimed is:

1. An integrated heat exchanger comprising:
a radiator including (1) a first tank and a second tank, and (2) a plurality of tubes extending between said first tank and said second tank, both ends of said plurality of tubes opening to inner spaces of said first tank and said second tank;
a condenser adjoining said radiator and sharing corrugated fins with said radiator, said condenser including a first tank, a second tank and a partition provided in said first tank, wherein coolant flows between said first tank and said second tank of said condenser while returning at least one time on a side of the second tank; and
opening/closing means being disposed in the inner space of said first tank of said radiator, said opening/closing means being opened when a temperature of cooling water reaches a given temperature or more, said opening/closing means being closed when the temperature of the cooling water is less than the given temperature, thereby partitioning the inner space of said first tank of said radiator into a first inner space and a second inner space, wherein a first group of said plurality of tubes opens to said first inner space of said first tank and a second group of said plurality of tubes opens to said second inner space of said first tank,
wherein, (A) when the temperature of the cooling water reaches the given temperature or more, the cooling water flows through the first inner space and the second inner space of said first tank, all of said plurality of tubes and the inner space of said second tank, and (B) when the temperature of the cooling water is less than the given temperature, the cooling water flows through the first inner space of said first tank, said first group of tubes and the inner space of said second tank, but not through the second inner space of said first tank and said second group of tubes, whereby all of said plurality of tubes serve heat transfer from the cooling water to outside air in the case of (A), and only said first group of tubes serves heat transfer from the cooling water to the outside air in the case of (B), and
wherein said radiator and said condenser are adjoins with each other so that a lower temperature side of the coolant flowing in said condenser adjoins said second group of tubes.

2. An integrated heat exchanger according to claim 1, wherein an inlet pipe of said radiator is disposed on said first inner space, and an inlet pipe of said condenser is disposed in said first tank of said condenser and adjacent to said inlet pipe of said radiator.

3. An integrated heat exchanger according to claim 1, wherein said opening/closing means comprises a partition formed on an inner side of said first tank of said radiator and having a through hole, and a valve for opening and closing the through hole of said partition.

4. An integrated heat exchanger according to claim 3, wherein said valve comprises a shape memory alloy.

5. An integrated heat exchanger according to claim 1, wherein the cooling water flows in said plurality of tubes only in a direction from said first tank to said second tank, and does not return from said second tank to said first tank.

6. An integrated heat exchanger comprising:
a radiator including (1) a first tank and a second tank, and (2) a plurality of tubes extending between said first tank and said second tank, both ends of said plurality of tubes opening to inner spaces of said first tank and said second tank, said plurality of tubes being categorized into a first group and a second group;
a condenser adjoining said radiator and sharing corrugated fins with said radiator; and
opening/closing means being disposed in the inner space of said first tank of said radiator,
wherein, (A) when a temperature of cooling water reaches a given temperature or more, said opening/closing means being opened and the cooling water flows through all of said plurality of tubes, and (B) when the temperature of the cooling water is less than the given temperature, the cooling water flows through the first group of tubes but not through the second group of tubes and
wherein said radiator and said condenser are adjoins with each other so that a lower temperature side of coolant flowing in said condenser adjoins said second group of tubes.

7. An integrated heat exchanger according to claim 6, wherein an inlet pipe of said radiator and an inlet pipe of said condenser are disposed adjacent with each other.

8. An integrated heat exchanger according to claim 6, wherein said opening/closing means comprises a partition formed on an inner side of said first tank of said radiator and having a through hole, and a valve for opening and closing the through hole of said partition.

9. The integrated heat exchanger according to claim 8, wherein said valve comprises a shape memory alloy.

10. An integrated heat exchanger according to claim 6, wherein the cooling water flows in said plurality of tubes only in a direction from said first tank to said second tank, and does not return from said second tank to said first tank.

11. An integrated heat exchanger according to claim 6, wherein said condenser has a first tank, a second tank and a partition provided in said first tank, wherein the coolant flows between said first tank and said second tank of said condenser while returning at least one time on a side of the second tank.
